(19) United States
(12) Patent Application Publication
(10) Pub. No.: US 2017/0320319 A1
(43) Pub. Date: Nov. 9, 2017

(54) PRINTING PRESS CLEANING DEVICE

(71) Applicant: KOMORI CORPORATION, Tokyo (JP)

(72) Inventor: Naohiro NAKAZAWA, Tsukuba-shi, Ibaraki (JP)

(21) Appl. No.: 15/522,247

(22) PCT Filed: Oct. 5, 2015
(86) PCT No.: PCT/JP2015/078183

§ 371 Date: Apr. 26, 2017

(30) Foreign Application Priority Data
Oct. 27, 2014 (JP) 2014-218595

(51) Int. Cl. B41F 35/04

(52) U.S. Cl. CPC B41F 35/04

(57) ABSTRACT

A printing press cleaning device includes a solvent supply nozzle (34) configured to supply a solvent containing a surfactant to an ink roller group (21) that includes a plurality of ink rollers configured to receive ink from an ink fountain (18a) and send the ink to a plate cylinder (17). The cleaning device includes a first or second cleaning solution supply nozzle (35, 36) configured to supply a first or second cleaning solution containing a volatile organic solvent to the ink roller group (21). The cleaning device includes a doctor blade (33) configured such that a distal end thereof can come into contact with and be moved away from an ink roller of the plurality of ink rollers, and scrape and collect the ink, the solvent, and the first or second cleaning solution of the ink roller group (21) at a contact position of the distal end that comes into contact with the ink roller. It is possible to provide a printing press cleaning device capable of shortening a cleaning time and improving an operation efficiency by efficient cleaning without increasing the supply amount of the cleaning solution.

### TECHNICAL FIELD

The present invention relates to a printing press cleaning device configured to clean ink rollers in a printing press for performing printing on a sheet or a web.

### BACKGROUND ART

Conventionally, to change the color of ink used in an ink supply device of a printing press, a plurality of ink rollers that supply the ink from an ink fountain to a plate cylinder are cleaned to remove the ink adhered to the ink rollers. As a conventional cleaning device for performing the cleaning, there is a device described in, for example, patent literature 1. In the cleaning device disclosed in patent literature 1, a cleaning solution containing a solvent for dissolving ink is supplied to ink rollers by a cleaning solution supply nozzle, and the dissolved ink and the cleaning solution are scraped by a doctor blade and collected.

By the way, the ink used in the printing press includes a so-called UV curing ink. The UV curing ink is cured when irradiated with UV rays, and its viscosity is higher than that of a general oil-based ink.

### RELATED ART LITERATURE

### Patent Literature

Patent Literature 1: Japanese Patent Laid-Open No. 10-193578

### DISCLOSURE OF INVENTION

### Problem to be Solved by the Invention

The UV curing ink has a high viscosity, and the conventional cleaning solution has high volatility to improve the cleaning properties. When cleaning is performed by the conventional cleaning device, the cleaning solvent cannot sufficiently circulate among the rollers due to the above-described reasons, and the cleaning properties may be poor. In this case, the ink is not completely removed and remains on the ink rollers. If the ink remains, the cleaning operation needs to be performed again, and much time is spent for the cleaning. The problem of cleaning properties and cleaning time largely affects productivity particularly for a user of frequent color change.

For this reason, conventional cleaning devices including the cleaning device described in patent literature 1 are required to improve the cleaning properties and further shorten the cleaning time.

To shorten the cleaning time, the cleaning solution supply amount may be increased to prompt the dissolution of the ink adhered to the ink rollers. However, since the discharge amount of the cleaning solution supply nozzle is limited, it is difficult to supply a large amount of cleaning solution in a short time. Even if a large amount of cleaning solution can be supplied, the time needed for collecting becomes long in proportion of the amount of cleaning solution, and therefore, the time needed until completion of cleaning cannot be shortened as much as expected. In addition, since the cleaning solution is a volatile organic solvent, the supply of a large amount of cleaning solution may deteriorate the work environment.

The present invention has been made to solve the above-described problem, and has as its object to provide a printing press cleaning device capable of shortening the cleaning time and improving the operation efficiency by efficient cleaning without increasing the supply amount of a cleaning solution.

Means of Solution to the Problem

In order to achieve the above object, according to the present invention, there is provided a printing press cleaning device comprising a solvent supply nozzle configured to supply a solvent containing a surfactant to an ink roller group that includes a plurality of ink rollers configured to receive ink from an ink fountain and send the ink to a plate cylinder, a cleaning solution supply nozzle configured to supply a cleaning solution containing a volatile organic solvent to the ink roller group, and a doctor blade configured such that a distal end thereof is capable of coming into contact with and moving away from an ink roller of the plurality of ink rollers, and the doctor blade configured to scrape and collect the ink, the solvent, and the cleaning solution of the ink roller group at a contact position of the distal end that comes into contact with the ink roller.

### Effect of the Invention

In the present invention, the surfactant is supplied to the ink rollers with ink and permeates between the ink and the surfaces of the ink rollers. Part of the ink floats from the surfaces of the ink rollers, and gaps are formed between the ink and the surfaces of the ink rollers. When the cleaning solution is supplied after the supply of the surfactant to the ink rollers, the cleaning solution enters the above-described gaps, thereby dissolving the ink from inside. The ink, the surfactant, and the cleaning solution can be removed in a short time by bringing the ink rollers into contact with each other or by bringing the ink rollers into contact with the doctor blade.

Hence, according to the present invention, it is possible to provide a printing press cleaning device capable of shortening the cleaning time and obtaining cleaning properties more improved than before without increasing the supply amount of the cleaning solution. As a result, since the number of times of automatic cleaning which is conventionally performed a plurality of times in some cases can be reduced to one, the operator can do another operation in the saved time. In addition, it is possible to greatly reduce the risk of re-printing caused by color mixture in printing using ink of another color.

### BRIEF DESCRIPTION OF DRAWINGS

FIG. 1 is a side view showing the arrangement of a printing press including a cleaning device according to the present invention;

FIG. 2 is a side view showing the arrangement of an ink supply device and the cleaning device;

FIG. 3 is a plan view for explaining the arrangement of nozzles;

FIG. 4 is a view for explaining the arrangement of a doctor blade and a doctor blade driving device, illustrated in a state in which the doctor blade retracted from an oscillating roller and a liquid waste collect tank are cut;

FIG. 5 is a block diagram showing the arrangement of a control system; and

FIG. 6 is a timing chart for explaining the operation of the cleaning device.

### BEST MODE FOR CARRYING OUT THE INVENTION

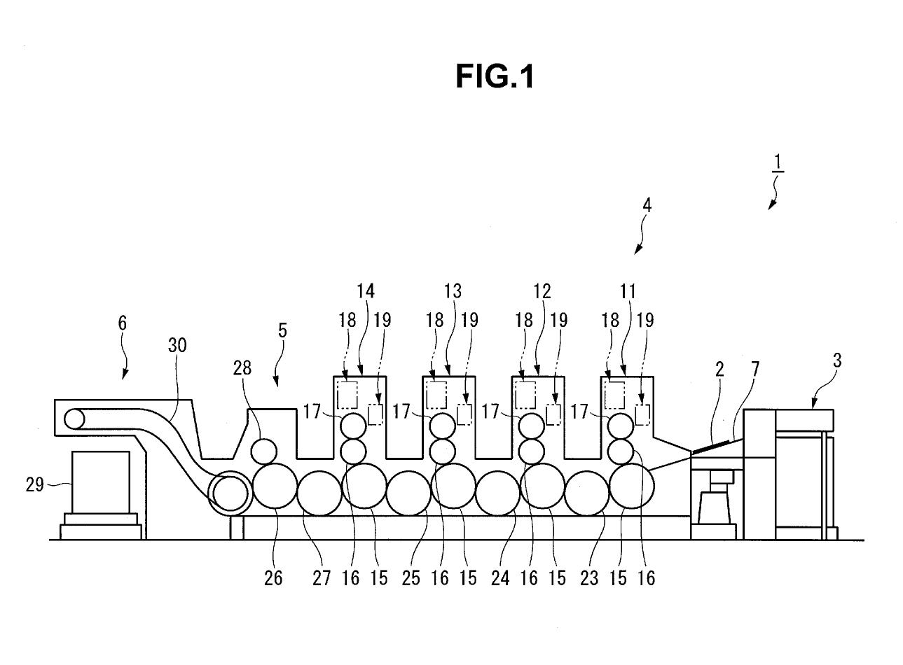

A printing press cleaning device according to an embodiment of the present invention will now be described in detail with reference to FIGS. 1 to 6.

A printing press 1 shown in FIG. 1 is a sheet-fed offset printing press that feeds a sheet 2 as a medium to be printed from right to left in FIG. 1, and performs printing and coating on the sheet 2. The printing press 1 includes a sheet supply unit 3 that supplies the sheet 2, a print unit 4 that performs printing on the sheet 2, a coating unit 5 that performs coating on the sheet 2, and a sheet discharge unit 6 configured to discharge the sheet 2.

The sheet supply unit 3 includes a sucker device (not shown) that sucks a number of stacked sheets 2 one by one, and a feeder board 7 that feeds the sheet 2 sucked by the sucker device to the print unit 4.

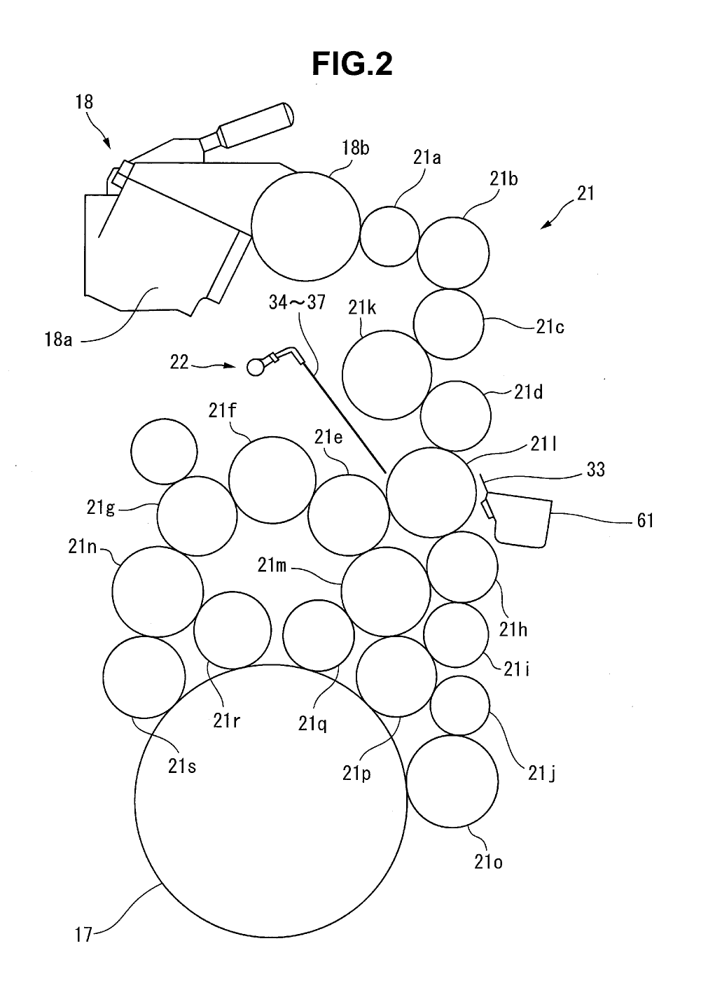

The print unit 4 includes first to fourth print units 11 to 14. Each of the first to fourth print units 11 to 14 includes an impression cylinder 15, a blanket cylinder 16, a plate cylinder 17, an ink supply device 18, a dampening device 19, and an ink roller group 21 and a cleaning device 22 both of which are shown in FIG. 2, as will be described later in detail.

The impression cylinder 15 in each of the first to fourth print units 11 to 14 includes a gripper device (not shown) that grips the sheet 2, and has a function of feeding the sheet 2 to the downstream side in the transportation direction. As shown in FIG. 1, first to third transfer cylinders 23 to 25 are provided between the impression cylinders 15 of the first to fourth print units 11 to 14. Each of the first to third transfer cylinders 23 to 25 includes a gripper device (not shown) that grips the sheet 2, and feeds the sheet 2 from the impression cylinder 15 located on the upstream side in the transportation direction to the impression cylinder 15 located on the downstream side. The impression cylinder 15 of the fourth print unit 14 feeds the sheet 2 to a fourth transfer cylinder 27 located between the impression cylinder 15 and an impression cylinder 26 of the coating unit 5 (to be described later). The fourth transfer cylinder 27 has the same structure as the first to third transfer cylinders 23 to 25.

The coating unit 5 includes the impression cylinder 26 to which the sheet 2 is fed from the fourth transfer cylinder 27, a coater cylinder 28 in contact with the impression cylinder 26, and a coating solution supply device (not shown) that transfers a coating solution to the coater cylinder 28.

The sheet discharge unit 6 includes a sheet pile 29 in which the sheet 2 is stacked, and a delivery chain 30 that transports the sheet 2 from the coating unit 5 onto the sheet pile 29.

The blanket cylinder 16 in each of the first to fourth print units 11 to 14 rotates in contact with the impression cylinder 15, and transfers ink to the sheet 2 sandwiched between the blanket cylinder 16 and the impression cylinder 15.

The plate cylinder 17 contacts the blanket cylinder 16 and transfers ink to the blanket cylinder 16.

The ink supply device 18 is configured as shown in FIG. 2, and supplies ink from an ink fountain 18a to an ink fountain roller 18b. The ink sent to the ink fountain roller 18b is sent to the plate cylinder 17 by the ink roller group 21 (to be described later).

The dampening device 19 supplies dampening water to the plate cylinder 17.

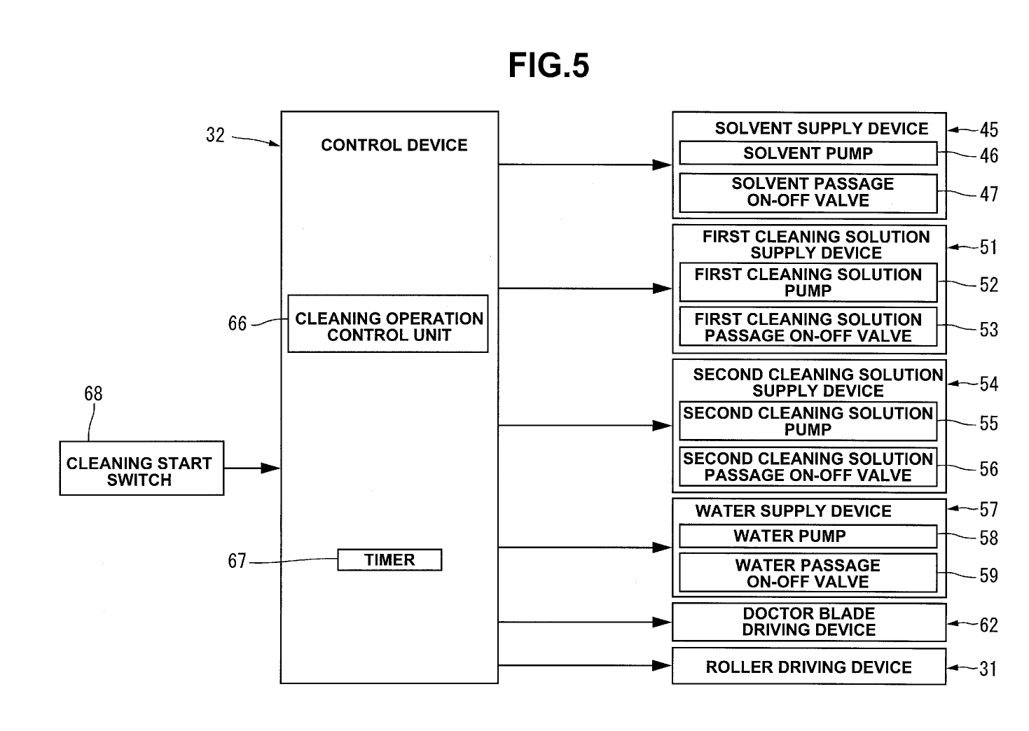

The ink roller group 21 includes a ductor roller 21a in contact with the ink fountain roller 18b, a plurality of distribution rollers 21b to 21j, a plurality of oscillating rollers 21k to 21n, and a plurality of ink form rollers 21o to 21s. Each of the rollers 21a to 21s is formed from a rubber roller. The rollers of the ink roller group 21 and the plate cylinder 17 are driven and rotated by a roller driving device 31 (see FIG. 5). The operation of the roller driving device 31 is controlled by a control device 32 (to be described later).

The cleaning device 22 is configured to clean the rollers 21a to 21s of the ink roller group 21. When changing ink colors after the end of printing in the first to fourth print units 11 to 14 or when saving the print units 11 to 14 in a stop state, the rollers 21a to 21s of the ink roller group 21 are cleaned by the cleaning device 22.

The cleaning device 22 according to this embodiment applies a plurality of types of liquids for cleaning to one roller (the oscillating roller 211 in FIG. 2), and collects the liquids for cleaning and the ink using a doctor blade 33 (see FIG. 2). When the liquids for cleaning are applied to the rotating oscillating roller 211, the liquids are transferred to other distribution rollers 21d, 21e, and 21h in contact with the oscillating roller 211 and then further transferred from these rollers to other rollers. As a result, the liquids for cleaning are supplied to all rollers 21a to 21s of the ink roller group 21.

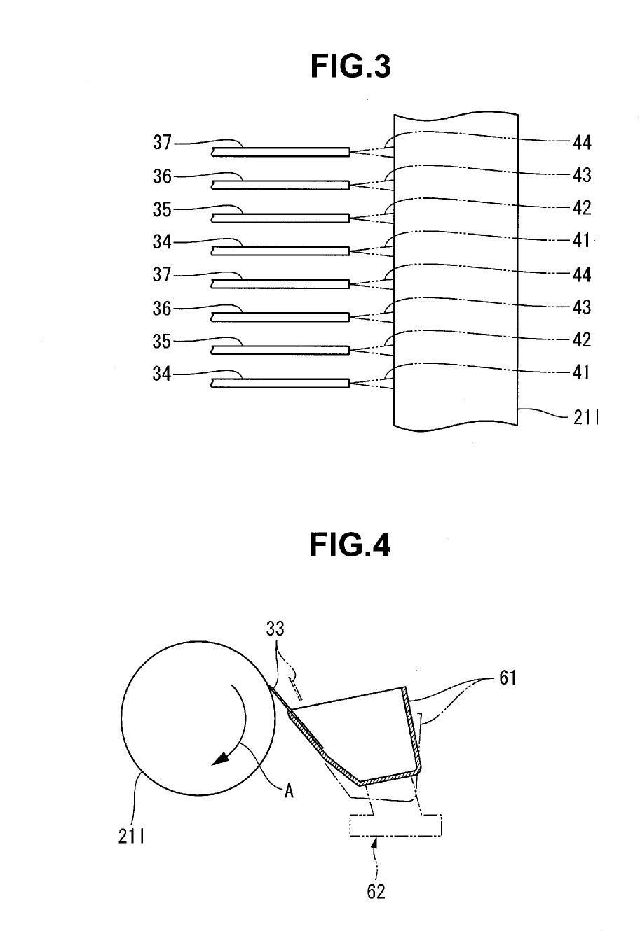

As shown in FIG. 3, the liquids for cleaning are supplied from a plurality of nozzles 34 to 37 to the oscillating roller 211. The plurality of nozzles 34 to 37 include the solvent supply nozzle 34, the first cleaning solution supply nozzle 35, the second cleaning solution supply nozzle 36, and the water supply nozzle 37. The nozzles 34 to 37 are arranged at a predetermined interval in the axial direction of the oscillating roller 211 in a state in which the nozzles are directed to the oscillating roller 211. Each of the nozzles 34 to 37 includes a plurality of nozzles.

The plurality of liquids for cleaning include a solvent 41 containing a surfactant, a first cleaning solution 42 containing a volatile organic solvent used to remove UV curing ink, a second cleaning solution 43 containing a volatile organic solvent used to remove oil-based ink, and water 44. As the first cleaning solution 42, a solution whose fluidity is higher than that of the second cleaning solution 43 is used.

The solvent 41 is supplied to the solvent supply nozzles 34 by a solvent supply device 45 (see FIG. 5), and supplied from the solvent supply nozzles 34 to the oscillating roller 211.

The solvent supply device 45 supplies the solvent 41 from a solvent tank (not shown) in which the solvent 41 is stored to the solvent supply nozzles 34 by a solvent pump 46. A solvent passage on-off valve 47 is provided in a solvent passage (not shown) between the solvent pump 46 and the solvent supply nozzles 34. The operations of the solvent pump 46 and the solvent passage on-off valve 47 are controlled by the control device 32.

The first cleaning solution 42 is supplied to the first cleaning solution supply nozzles 35 by a first cleaning solution supply device 51, and supplied from the first cleaning solution supply nozzles 35 to the oscillating roller 211. The first cleaning solution supply device 51 supplies the first cleaning solution 42 from a first cleaning solution tank (not shown) in which the first cleaning solution 42 is stored to the first cleaning solution supply nozzles 35 by a first cleaning solution pump 52. A first cleaning solution passage on-off valve 53 is provided in a cleaning solution passage (not shown) between the first cleaning solution pump 52 and the first cleaning solution supply nozzles 35. The operations of the first cleaning solution pump 52 and the first cleaning solution passage on-off valve 53 are controlled by the control device 32.

The second cleaning solution 43 is supplied to the second cleaning solution supply nozzles 36 by a second cleaning solution supply device 54, and supplied from the second cleaning solution supply nozzles 36 to the oscillating roller 211. The second cleaning solution supply device 54 supplies the second cleaning solution 43 from a second cleaning solution tank (not shown) in which the second cleaning solution 43 is stored to the second cleaning solution supply nozzles 36 by a second cleaning solution pump 55. A second cleaning solution passage on-off valve 56 is provided in a cleaning solution passage (not shown) between the second cleaning solution pump 55 and the second cleaning solution supply nozzles 36. The operations of the second cleaning solution pump 55 and the second cleaning solution passage on-off valve 56 are controlled by the control device 32.

The water 44 is supplied to the water supply nozzles 37 by a water supply device 57, and supplied from the water supply nozzles 37 to the oscillating roller 211. The water supply device 57 supplies the water 44 from a water tank (not shown) in which the water 44 is stored to the water supply nozzles 37 by a water pump 58. A water passage on-off valve 59 is provided in a water passage (not shown) between the water pump 58 and the water supply nozzles 37. The operations of the water pump 58 and the water passage on-off valve 59 are controlled by the control device 32.

As shown in FIG. 4, the doctor blade 33 is formed into a plate shape in a size capable of contacting the entire outer surface of the oscillating roller 211, and attached to a liquid waste collect tank 61 located near the oscillating roller 211. The doctor blade 33 extends from one end of the liquid waste collect tank 61 obliquely upward to the upper side of the oscillating roller 211, and substantially forms the opening edge at the one end of the liquid waste collect tank 61.

The liquid waste collect tank 61 is formed into a box shape open upward and swingably supported by a doctor blade driving device 62 (to be described later). A liquid waste is stored in the liquid waste collect tank 61. The liquid waste here is a liquid mixture containing the used solvent 41, the first or second cleaning solution 42 or 43, the water 44, and removed ink.

The doctor blade driving device 62 has a function of moving the liquid waste collect tank 61 between a retracting position indicated by an alternate long and two short dashed line in FIG. 4 and a use position indicated by a solid line in FIG. 4. When the liquid waste collect tank 61 is located at the retracting position, the doctor blade 33 is moved away from the oscillating roller 211 and moves to the retracting position. When the liquid waste collect tank 61 is located at the use position, the doctor blade 33 is located at a contact position shown in FIG. 4. When the doctor blade 33 is located at the contact position, the distal end (upper end) of the doctor blade 33 comes into contact with the outer surface of the oscillating roller 211. That is, the doctor blade 33 is configured such that the distal end thereof can come into contact with and be moved away from the oscillating roller 211 (ink roller).

The doctor blade 33 contacts the oscillating roller 211 in a state in which the oscillating roller 211 is rotating in a direction (a direction in which the contact portion to the doctor blade 33 moves to the side of the doctor blade 33) indicated by an arrow A in FIG. 4. When the doctor blade 33 contacts the oscillating roller 211 in this way, the liquids such as the ink and the cleaning solution adhered to the outer surface of the oscillating roller 211 are scraped by the doctor blade 33, brought down to the liquid waste collect tank 61, and discharged as a liquid waste.

The operation of the doctor blade driving device 62 is controlled by the control device 32.

The control device 32 includes a cleaning operation control unit 66 that controls the operations of the cleaning device 22, the roller driving device 31, and the like described above, and a timer 67. A cleaning start switch 68 to be operated by the operator (not shown) when starting cleaning by the cleaning device 22 is connected to the control device 32.

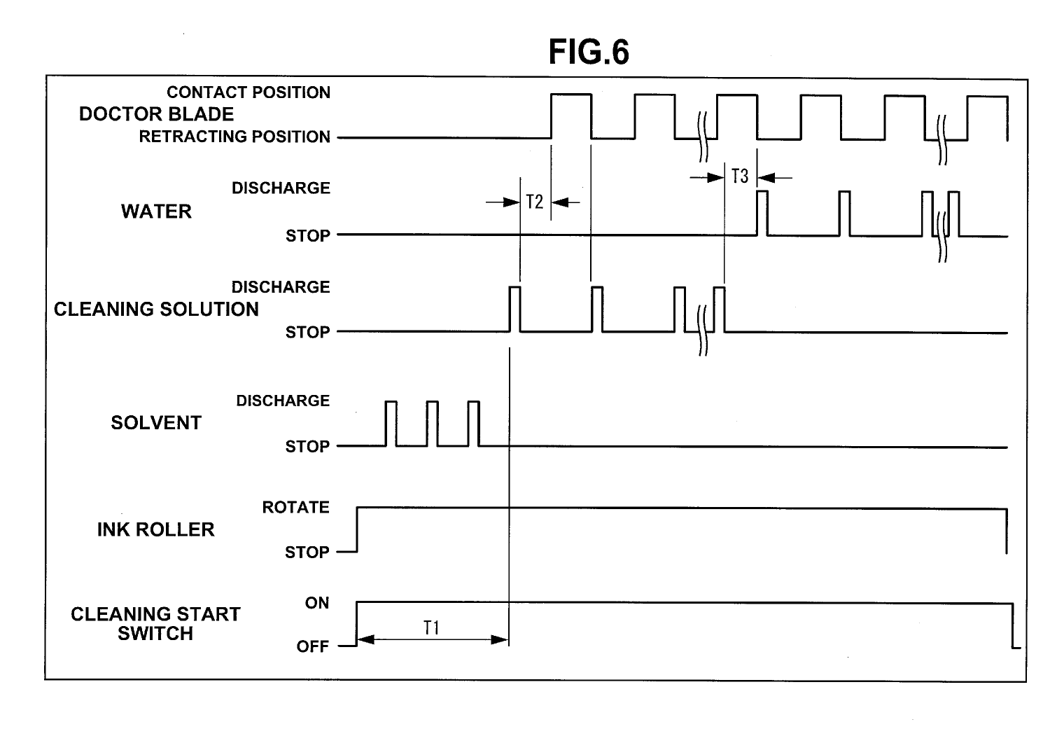

A more detailed arrangement of the control device 32 will be described here with reference to the timing chart of FIG. 6.

When the cleaning start switch 68 is operated, the control device 32 first operates the roller driving device 31 to rotate the rollers 21a to 21s of the ink roller group 21. The control device 32 operates the solvent supply device 45 to discharge the solvent 41 from the solvent supply nozzles 34. The solvent 41 is discharged from the solvent supply nozzles 34 for a predetermined time. In the form shown in FIG. 6, the solvent 41 is applied three times at a predetermined interval. Note that the application time or application count of the solvent 41 can be changed as needed in accordance with the ink adhering state.

Application of the solvent 41 is done after the cleaning start switch 68 is operated until a predetermined time T1 elapses. The time T1 is set to a time needed to send the solvent 41 to all rollers of the ink roller group 21. The time T1 is counted by the timer 67. The solvent 41 containing a surfactant is supplied to the rollers with ink and permeates between the ink and the surfaces of the rollers. Part of the ink floats from the surfaces of the rollers, and gaps are formed between the ink and the surfaces of the rollers.

After the elapse of the time T1, the control device 32 operates the first cleaning solution supply device 51 or the second cleaning solution supply device 54 to discharge the first cleaning solution 42 or the second cleaning solution 43 from the first cleaning solution supply nozzles 35 or the second cleaning solution supply nozzles 36. To clean rollers using UV curing ink, the first cleaning solution supply device 51 operates. On the other hand, to clean rollers using oil-based ink, the second cleaning solution supply device 54 operates.

The first cleaning solution 42 or the second cleaning solution 43 is discharged from the first cleaning solution supply nozzles 35 or the second cleaning solution supply nozzles 36 for a predetermined period of time. The first cleaning solution 42 or the second cleaning solution 43 is discharged repetitively a predetermined number of times at a predetermined interval. The discharge count of the first cleaning solution 42 or the second cleaning solution 43 can be changed as needed in accordance with the ink adhering state.

When the first cleaning solution 42 or the second cleaning solution 43 is supplied after the supply of the solvent 41 to the ink rollers, the surface of the ink is dissolved by the first cleaning solution 42 or the second cleaning solution 43. In addition, the first cleaning solution 42 or the second cleaning solution 43 enters the above-described gaps, thereby dissolving the ink from inside.

After a predetermined time T2 elapses from the first discharge of the first cleaning solution 42 or the second cleaning solution 43, the control device 32 operates the doctor blade driving device 62 to move the doctor blade 33 from the retracting position to the contact position.

When the doctor blade 33 comes into contact with the outer surface of the oscillating roller 211, the liquid (the used solvent 41 or a solution made by dissolving the ink by the first cleaning solution 42 or the second cleaning solution 43) adhered to the oscillating roller 211 is scraped as a liquid waste by the doctor blade 33. The liquid waste flows to the liquid waste collect tank 61 and is discharged.

When the oscillating roller 211 contacts the distribution rollers 21d, 21e, and 21h, the liquids adhered to the distribution rollers 21d, 21e, and 21h are transferred to the portion of the oscillating roller 211 where the doctor blade 33 has scraped the liquid. For this reason, the liquids adhered to the distribution rollers 21d, 21e, and 21h decrease, and liquids are transferred from other rollers in contact with the distribution rollers 21d, 21e, and 21h to the distribution rollers 21d, 21e, and 21h. Hence, the liquids adhered to the rollers of the ink roller group 21 are moved to the oscillating roller 211 via the rollers and collected from the oscillating roller 211 to the liquid waste collect tank 61.

After the doctor blade 33 is held at the contact position for a predetermined time, the control device 32 operates the doctor blade driving device 62 to move the doctor blade 33 to the retracting position. In this embodiment, when the doctor blade 33 moves to the retracting position, the first cleaning solution supply nozzles 35 or the second cleaning solution supply nozzles 36 discharge the first cleaning solution 42 or the second cleaning solution 43 again. When the time T2 elapses from the end of the discharge, the control device 32 operates the doctor blade driving device 62 again to move the doctor blade 33 from the retracting position to the contact position.

That is, the control device 32 has a function of alternately repetitively operating the first cleaning solution supply device 51 or the second cleaning solution supply device 54 and the doctor blade driving device 62 in this order after the solvent supply device 45 is operated. For this reason, after the solvent 41 is supplied to the ink roller group 21, the first cleaning solution 42 or the second cleaning solution 43 is supplied, and the ink, the used solvent 41, and the first cleaning solution 42 or the second cleaning solution 43 are collected by the doctor blade 33.

The control device 32 intermittently operates the first cleaning solution supply device 51 or the second cleaning solution supply device 54 a predetermined number of times as described above, and then stops the device. Even after the first cleaning solution supply device 51 or the second cleaning solution supply device 54 is stopped, the control device 32 repetitively operates the doctor blade driving device 62 until the cleaning operation ends.

After the elapse of a predetermined time T3 from the stop of the first cleaning solution supply device 51 or the second cleaning solution supply device 54, the control device 32 operates the water supply device 57 to discharge the water 44 from the water supply nozzles 37. That is, the control device 32 has a function of operating the water supply device 57 after the solvent supply device 45, the first cleaning solution supply device 51 or the second cleaning solution supply device 54, and the doctor blade driving device 62 are operated. Hence, after the cleaning operation using the solvent 41 and the first cleaning solution 42 or the second cleaning solution 43 is completed, the water 44 is supplied from the water supply nozzles 37 to the ink roller group 21, and foreign substances remaining on the rollers are washed away by the water 44.

The water 44 is discharged from the water supply nozzles 37 for a predetermined time. The water 44 is discharged repetitively a predetermined number of times at a predetermined interval. The discharge count of the water 44 can be changed as needed in accordance with the ink adhering state.

After the water supply device 57 stops, and the collecting operation by the doctor blade 33 is performed a predetermined number of times, the control device 32 stops the doctor blade driving device 62, and stops the driving by the roller driving device 31 to stop the rollers 21a to 21s of the ink roller group 21.

When the rollers 21a to 21s stops, the cleaning operation of the cleaning device 22 is completed.

In the cleaning device 22 of the printing press 1 with the above-described arrangement, the solvent 41 containing a surfactant is supplied to the rollers with ink and permeates between the ink and the surfaces of the rollers. Part of the ink floats from the surfaces of the rollers, and gaps are formed between the ink and the surfaces of the rollers. When the first cleaning solution 42 or the second cleaning solution 43 is supplied after the supply of the solvent 41 to the rollers, the first cleaning solution 42 or the second cleaning solution 43 enters the above-described gaps, thereby dissolving the ink from inside. The ink, the solvent 41, and the first cleaning solution 42 or the second cleaning solution 43 can be removed in a short time by bringing the rollers into contact with each other or by bringing the rollers into contact with the doctor blade 33.

Hence, according to this embodiment, it is possible to provide a printing press cleaning device capable of shortening the cleaning time and obtaining cleaning properties more improved than before without increasing the supply amount of the first cleaning solution 42 or the second cleaning solution 43. As a result, since the number of times of automatic cleaning which is conventionally performed a plurality of times in some cases can be reduced to one, the operator can do another operation in the saved time. In addition, it is possible to greatly reduce the risk of re-printing caused by color mixture in printing using ink of another color.

In addition, since the residue of fine ink components on the ink rollers is removed, glaze can be prevented. Glaze is a phenomenon in which micropores in a rubber surface are clogged with a residue of ink and other foreign substances. According to the cleaning device 22 of this embodiment, since the surfaces of the ink rollers are sufficiently cleaned, and glaze can be prevented, an ink transfer failure does not occur when performing printing using the next ink. As a result, when printing is started using the next ink, wasted paper can be reduced, and a printing product can quickly obtain a predetermined color.

The cleaning device 22 according to this embodiment includes the solvent supply device 45 configured to supply the solvent 41 to the solvent supply nozzles 34, the first cleaning solution supply device 51 or the second cleaning solution supply device 54 configured to supply the first cleaning solution 42 or the second cleaning solution 43 to the first cleaning solution supply nozzles 35 or the second cleaning solution supply nozzles 36, the doctor blade driving device 62 configured to drive the doctor blade 33, and the control device 32 configured to control the operations of the solvent supply device 45, the cleaning solution supply devices, and the doctor blade driving device 62. The control device 32 has a function of performing the cleaning operation of operating the first cleaning solution supply device 51 or the second cleaning solution supply device 54 and the doctor blade driving device 62 after the solvent supply device 45 is operated. In this embodiment, after the solvent supply device 45 is operated, the first cleaning solution supply device 51 or the second cleaning solution supply device 54 and the doctor blade driving device 62 alternately repetitively operate in this order.

According to the cleaning device 22 of this embodiment, after the solvent 41 is supplied to the ink roller group 21, the first cleaning solution 42 or the second cleaning solution 43 is supplied, and the ink, the solvent 41, and the first cleaning solution 42 or the second cleaning solution 43 are collected by the doctor blade 33.

For this reason, the step of making the ink slightly float from the ink rollers, the step of dissolving the ink by the first cleaning solution 42 or the second cleaning solution 43, and the step of collecting the ink, the solvent 41, and the first cleaning solution 42 or the second cleaning solution 43 are automatically executed in this order. It is therefore possible to provide a printing press cleaning device that completes the cleaning step in a shorter time because the cleaning is automatically performed in the order capable of quickly removing the ink.

The cleaning device 22 according to this embodiment includes the water supply nozzles 37 configured to supply the water 44 to the ink roller group 21, and the water supply device 57 configured to supply the water 44 to the water supply nozzles 37. The control device 32 according to this embodiment also has a function of operating the water supply device 57 after the above-described cleaning operation is performed (after the solvent supply device 45, the first cleaning solution supply device 51 or the second cleaning solution supply device 54, and the doctor blade driving device 62 are operated). According to the cleaning device 22 of this embodiment, after the cleaning operation using the solvent 41 and the first cleaning solution 42 or the second cleaning solution 43 is completed, the water 44 is supplied to the ink roller group 21 by the water supply nozzles 37.

For this reason, according to this embodiment, after the cleaning using the first cleaning solution 42 or the second cleaning solution 43, the residue on the ink rollers can be washed away by the water 44. It is therefore possible to provide a printing press cleaning device capable of sufficiently cleaning the ink rollers although the cleaning time is short.

Explanation of the Reference Numerals and Signs

1 . . . printing press, 17 . . . plate cylinder, 18a . . . ink fountain, 21 . . . ink roller group, 21a-21s . . . roller, 22 . . . cleaning device, 33 . . . doctor blade, 34 . . . solvent supply nozzle, 35 . . . first cleaning solution supply nozzle, 36 . . . second cleaning solution supply nozzle, 41 . . . solvent, 42 . . . first cleaning solution, 43 . . . second cleaning solution.

1. A printing press cleaning device comprising:
a solvent supply nozzle configured to supply a solvent containing a surfactant to an ink roller group that includes a plurality of ink rollers configured to receive ink from an ink fountain and send the ink to a plate cylinder;
a cleaning solution supply nozzle configured to supply a cleaning solution containing a volatile organic solvent to the ink roller group; and
a doctor blade configured such that a distal end thereof is capable of coming into contact with and moving away from an ink roller of the plurality of ink rollers, and the doctor blade configured to scrape and collect the ink, the solvent, and the cleaning solution of the ink roller group at a contact position of the distal end that comes into contact with the ink roller.

2. The printing press cleaning device according to claim 1, further comprising:
a solvent supply device configured to supply the solvent to the solvent supply nozzle;
a cleaning solution supply device configured to supply the cleaning solution to the cleaning solution supply nozzle;
a doctor blade driving device configured to drive the doctor blade; and
a control device configured to control operations of the solvent supply device, the cleaning solution supply device, and the doctor blade driving device,
wherein the control device has a function of performing a cleaning operation of operating the cleaning solution supply device and the doctor blade driving device after the solvent supply device is operated.

3. The printing press cleaning device according to claim 2, further comprising:
a water supply nozzle configured to supply water to the ink roller group; and
a water supply device configured to supply water to the water supply nozzle,
wherein the control device further has a function of operating the water supply device after the cleaning operation is performed.
